(19) United States
(12) Patent Application Publication
(10) Pub. No.: US 2008/0046888 A1
(43) Pub. Date: Feb. 21, 2008

(54) Framework for Rule-Based Execution and Scheduling of Tasks in Mobile Devices

(76) Inventor: Anuradha K. Appaji, Plano, TX (US)

Correspondence Address: CONLEY ROSE, P.C., 5601 GRANITE PARKWAY, SUITE 750, PLANO, TX, 75024, US

(21) Appl. No.: 11/610,009

(22) Filed: Dec. 13, 2006

Related U.S. Application Data
(60) Provisional application No. 60/822,453, filed on Aug. 15, 2006.

(51) Int. Cl. G06F 9/46

(52) U.S. Cl. 718/102; 718/100

(57) ABSTRACT

A system is provided. The system comprises a component to receive a device management object. The device management object includes a rule node containing a rule that promotes control of execution of a task on a mobile device based on a parameter in a node in the device management object.

### CROSS-REFERENCE TO RELATED APPLICATIONS

This application claims priority to U.S. Provisional Patent Application No. 60/822,453, entitled “Framework for Rule Based Execution and Scheduling of Tasks in Mobile Devices”, filed on Aug. 15, 2006, by Anuradha K. Appaji, et al., which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Devices such as mobile telephones, personal digital assistants, handheld computers, and similar devices will be referred to herein as mobile devices. It is well known in the art that some mobile devices can automatically execute self-diagnostic tasks. For example, a mobile device might collect information on the usage patterns of the mobile device's user, on the mobile device's performance metrics, and on other parameters. A telecommunications service provider that provides services to the mobile device might wish to collect this information. In a typical scenario, a server computer operated by the provider might wirelessly transmit a command to a mobile device instructing the mobile device to perform a task. After performing the task, the mobile device might wirelessly transmit the data generated by the performance of the task back to the server. The provider might then analyze the data to determine if adjustments in service or other changes need to be made.

### SUMMARY

In one embodiment, a system is provided. The system comprises a component to receive a device management object. The device management object includes a rule node containing a rule that promotes control of execution of a task on a mobile device based on a parameter in a node in the device management object.

In another embodiment, a system is provided. The system comprises a server and a mobile device. The mobile device includes a first component and a second component. The first component is operable to receive a device management object from the server. The device management object is operable to contain a rule that can control the execution of a task on the mobile device based on a parameter in a node in at least one of the device management object and another device management object. The second component is operable to send data generated by the execution of the task to the server.

In another embodiment, a method for controlling an execution of a task on a mobile device is provided. The method comprises specifying a rule related to the execution of the task in a rule node in a device management object. The rule is operable to cause at least one of the execution of a first task when a first condition for the execution of the first task is not met and the prevention of the execution of a second task when a second condition for the execution of the second task is met. The method further comprises transmitting the device management object to the mobile device and, when at least one of the first condition and the second condition are met, enforcing the rule.

These and other aspects of the disclosure will be more clearly understood from the following detailed description taken in conjunction with the accompanying drawings and claims.

### BRIEF DESCRIPTION OF THE DRAWINGS

For a more complete understanding of the disclosure and the advantages thereof, reference is now made to the following brief description, taken in connection with the accompanying drawings and detailed description, wherein like reference numerals represent like parts.

FIG. 1 illustrates a device management data framework according to an embodiment of the disclosure.

FIG. 2 illustrates a schedule context for tasks on a mobile device according to an embodiment of the disclosure.

FIG. 3 illustrates a method for controlling the execution of tasks on a mobile device according to an embodiment of the disclosure.

FIG. 4 is a diagram of a wireless communications system including a mobile device operable for some of the various embodiments of the disclosure.

FIG. 5 is a block diagram of a mobile device operable for some of the various embodiments of the disclosure.

FIG. 6 is a diagram of a software environment that may be implemented on a mobile device operable for some of the various embodiments of the disclosure.

### DETAILED DESCRIPTION

It should be understood at the outset that although an illustrative implementation of one or more embodiments are provided below, the systems and methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The Open Mobile Alliance (OMA) has developed a device management framework that allows telecommunications service providers to send commands to their subscribers' mobile devices. The OMA standards suggest that a standard data structure be followed for the data object used to send the commands. The commands can allow the providers' servers to schedule tasks for execution on the mobile devices based on conditions within the mobile devices. The OMA standards define an extensible markup language (XML) object for transmitting the commands. The use of an XML format for the device management object improves interoperability among different providers and mobile device manufacturers since XML is a standardized format that most mobile devices can read. The device management object is described in the OMA document entitled “Device Management Scheduling Management Object”, Draft Version 1.0-2 Nov. 2006, document number OMA-TS-DM-SchedMO-V1_{—}0_{—}0-20061102-D, which is incorporated herein by reference for all purposes.

Without a standardized format, if multiple providers needed to interact with mobile devices from multiple different manufacturers, each manufacturer might need to publish guidelines for interacting with the mobile devices that it produces. Each provider might then need to develop different protocols for sending commands to each manufacturer's mobile devices. If, instead, the mobile devices receive commands in the XML format, there is no need for the manufacturers to publish information about communicating with their mobile devices. The XML object standardizes communication between the providers' servers and the mobile devices so that the providers can send commands in the same format regardless of the manufacturer of the mobile device. While the OMA standards currently specify an XML format and the following discussion will focus on an XML format, it should be understood that other formats could be used to standardize communications between the servers and the mobile devices.

Telecommunications providers may be interested in receiving information about tasks, such as processes or activities, running on their subscribers' mobile devices. All of the data produced by all of the tasks that run on a mobile device might then be transmitted to the provider. This might lead to the provider receiving a great deal of task-related data from a mobile device regardless of whether the provider actually wishes to make use of all of that data. For example, a mobile device user might make the greatest use of the voice communication features of a mobile device and might rarely use other features such as data communication and photography. Tasks related to the rarely used features would still be executed on such a user's mobile device and the results of the tasks would be transmitted to the provider. The provider might be interested only in the voice-related data for such a user, but would still receive information about the rarely used features.

The provider might wish to avoid receiving unwanted data by preventing a task from executing when the data generated by the task is not relevant to the provider. However, under the current OMA device management frameworks, tasks will automatically be executed whenever their conditions are met. A mechanism for preventing tasks from running despite their conditions being met is not provided. Similarly, the current OMA device management frameworks do not provide a mechanism for causing tasks to be executed when the conditions for the tasks have not been met.

In an embodiment, an OMA-compliant device management object tree or framework is provided that includes a node that can contain a rule that can, for example, override the conditions for executing tasks. That is, when one of the conditions in a schedule in this device management object tree is met, a rule is consulted to determine whether the task associated with that schedule should be executed. The rule might prevent a task from being executed despite the conditions for that task being met or might cause a task to be executed even though the conditions for that task have not been met. In addition, this device management framework can provide visibility to the tasks in other data objects. For example, a rule in a first data object might prevent a scheduled task in a second data object from executing or might cause a task in a second data object to execute even though the task in the second object is not scheduled to execute.

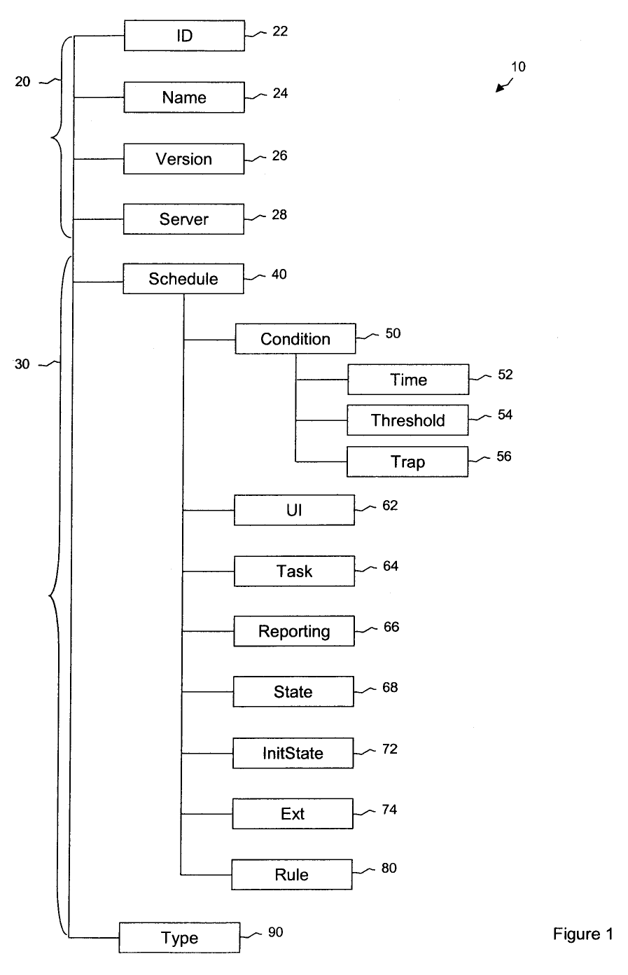

FIG. 1 illustrates an embodiment of a data structure or object that might be used for such rule-based execution of tasks. This example is merely intended to illustrate several of the nodes that are particularly pertinent to the rule-based scheduling and execution of tasks on mobile devices. One of skill in the art will recognize that the structure might include additional nodes, that all of the illustrated nodes need not be present, and that the nodes might be arranged differently.

In this embodiment, a device management object 10 includes an overhead portion 20, which might also be referred to as a header portion, and a schedule portion 30, which might also be referred to as a task portion. The overhead portion 20 might contain information that is the same for multiple related schedule portions 30. In this example, the overhead portion 20 includes an ID node 22, a name node 24, a version node 26, and a server node 28.

The ID node 22 uniquely identifies a set of related objects 10 that use the same overhead portion 20. The name node 24 might be used to give the set of related objects 10 a name that is easier to remember than the ID specified in the ID node 22. The version node 26 might specify the version of the OMA device management standard that is being followed or other version information. The server that is transmitting the object 10 might use the server node 28 to identify itself.

The schedule portion 30 is typically different for each task-related command sent to a mobile device. In the example of FIG. 1, the schedule portion 30 contains a schedule node 40 at the same hierarchical level as the nodes in the overhead portion 20. Under the schedule node 40, in this example, are a condition node 50, a UI node 62, a task node 64, a reporting node 66, a state node 68, an InitState node 72, an ext node 74, and a rule node 80.

The condition node 50 is used to specify a condition that will cause a task to be executed on a mobile device to which the device management object 10 is sent. In this example, three different types of conditions, represented by a time node 52, a threshold node 54, and a trap node 56, can cause a task to be launched. The time node 52 can specify a time when a task is to be executed. The time might be an absolute clock time or a relative time dependent on some other occurrence on a mobile device. The time might specify when a one-time-only task is to occur or might specify times for a recurring task.

The threshold node 54 can be used to cause a task to be executed when a threshold for a parameter of a mobile device is reached. Numerous thresholds might exist for the activities that occur in a mobile device. For example, there may be a minutes used threshold, a battery level threshold, a memory capacity threshold, a dropped calls threshold or other thresholds that will be familiar to one of skill in the art. A field in the threshold node 54 can cause a task to be launched on a mobile device when such a threshold is reached.

The trap node 56 can be used to cause a task to be executed when an event other than the crossing of a threshold occurs on a mobile device. Thus, the three types of condition that can cause a task to be executed can be referred to as ‘time’, ‘threshold’, and ‘event’.

The UI node 62 deals with information that might appear on the display screen of a mobile device when a task is executed. The task node 64 designates the task that will be executed when a condition specified in the condition node 50 is met. There is typically only one task in one task node 64 and one task node 64 under one schedule node 40. That is, a task might be defined as one or more actions that occur when a condition specified in a schedule is met. The reporting node 66 allows a mobile device to report the results of the execution of a task back to the server.

The state node 68 specifies the status of a task that is currently executing on a mobile device. Examples of task status might include ‘running’ for a task that is currently executing, ‘complete’ for a task that has successfully completed execution, and ‘error’ for a task that did not successfully complete execution. The InitState, or initial state, node 72 allows the server to specify that a task is to be executed on a mobile device upon receipt of the data framework object 10 even if the conditions for performing the task are not met when the object 10 is received. Thereafter, the task is to be performed only when the conditions are met.

The ext node 74 allows manufacturers or vendors to add their own extensions to the data framework object 10. This can provide the manufacturers the opportunity to customize the data framework object 10 as they desire. However, customization of the data framework object 10 can reduce interoperability when devices from multiple manufacturers provide the results of the execution of tasks to multiple telecommunications service providers.

One of skill in the art will recognize that the condition node 50 contains information related to conditions, the task node 64 contains information related to tasks, and so on. Hereinafter, the name of a node and the information contained in that node will be used interchangeably. For example, the term ‘condition 50’ might refer to the condition node 50 or to the condition contained in the condition node 50, the term ‘task 64’ might refer to the task node 64 or to the task contained in the task node 64, and so on.

The rule node 80 that branches from the schedule node 40 allows rules to be applied to the scheduling and execution of tasks 64. The rule node 80 can contain one or more rules 80 regarding whether or not a task 64 is to be executed. The rule 80 can be based on a time, threshold, or event in the condition node 50 or can be based on information in the reporting node 66, the state node 68, the InitState node 72, or other nodes in the schedule 40 or in another schedule. The rule 80 can apply to the task 64 in the same schedule 40 that contains the rule 80 or can apply to a task in a different schedule.

As an example, a rule for a first task in a first schedule might state that if a second task in a second schedule has not completed, then the first task should not begin execution even if a condition for executing the first task has been met. In this case, the rule in the first schedule would be based on information in the state node 68 of the second schedule.

As another example, a rule for a first task in a first schedule might state that if a second task in a second schedule has completed but a report for the second task has not been generated, then the first task should not begin execution even if a condition for executing the first task has been met. In this case, the rule in the first schedule would be based on information in the reporting node 66 and the state node 68 of the second schedule.

As yet another example, a rule in a first schedule might cause a condition for a task in a second schedule to be met when the condition for the task would not otherwise be met. For instance, the task in the second schedule might normally execute only when a particular event specified in the trap node 56 of the second schedule occurs. The rule in the first schedule might cause a flag or other indicator to be set to indicate to the second schedule that the event has occurred even though the event has not actually occurred. This could cause the task to execute even though a condition for executing the task has not actually been met. One of skill in the art will recognize other ways in which a rule in the rule node 80 of the schedule portion 30 of the device management object 10 could cause a task to execute that would not otherwise execute or cause a task that would normally execute not to execute.

The use of rules 80 allows the execution of tasks 64 to be based not just on a single time or a single threshold or a single event. Instead, complex combinations of times, thresholds, events, and/or other parameters under the schedule node 40 can be used to determine whether the task 64 under the schedule node 40 should be executed or whether a task under another schedule node should be executed.

Also, the use of rules 80 provides visibility between multiple schedules 40. Previously, the determination of whether to execute a task 64 was based strictly on the conditions 50 in the schedule 40 for that task 64. With the inclusion of the rule node 80 in the device management object tree 10, the task 64 in the schedule 40 might or might not be executed depending on the parameters of another schedule. Similarly, a task in another schedule might or might not be executed depending on the parameters of the schedule 40.

By using rules 80, a provider can exercise greater control over the data that is collected from mobile devices. Tasks 64 that generate data that is not relevant to the provider can be prevented from executing. Tasks 64 that are allowed to execute can generate data that is fine tuned to match the provider's needs. This can make the provider's analysis of the data received from mobile devices more efficient and can reduce the bandwidth needed to transmit mobile device data to the provider.

In an embodiment, rules 80 are applied only to schedules 40 within the same schedule context. As is well known in the art, the term ‘context’, when used in reference to mobile devices, refers to a set of related functions on a mobile device. Information related to separate contexts is typically collected by separate servers. For example, one server might collect usage pattern information and another server might collect measurements related to radio frequency transmissions. Usage pattern information and radio frequency information would be considered separate contexts. Within the usage pattern context, for example, there may be a voice call context, a data call context, a camera context, and other contexts. Additional contexts will be familiar to one of skill in the art. A plurality of schedules 40 would typically be present in a schedule context. A telecommunications service provider might specify which schedules 40 belong in which contexts.

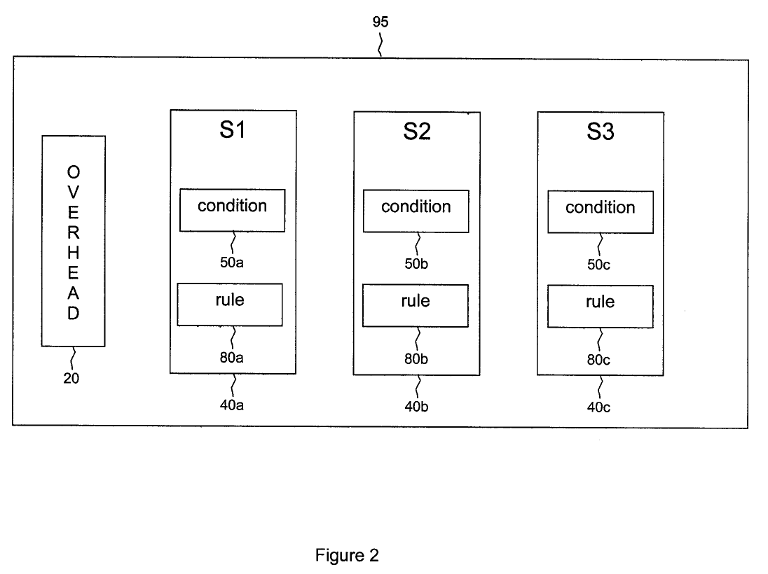

FIG. 2 illustrates an embodiment of a schedule context 95. A single overhead portion 20 applies to a plurality of schedules 40. While three schedules 40 are shown in the schedule context 95 of FIG. 2, in other embodiments other numbers of schedules 40 could be present. Each schedule 40 contains a plurality of nodes including the condition node 50 and the rule node 80. Other nodes shown under the schedule node 40 in FIG. 1 are not shown in FIG. 2 but might be present in each schedule 40 in FIG. 2. In an embodiment, a rule in one of the rule nodes 80 applies only to one of the schedules 40 within the schedule context 95. For example, a rule in the rule node 80a might apply to the schedule 40a, the schedule 40b, the schedule 40c, or any combination of those schedules 40. A rule in the rule node 80a would not apply to a schedule not present in the schedule context 95.

In an embodiment, a condition in the condition node 50 of the schedule 40 is met before the rule 80 in that schedule 40 is applied. That is, the rule 80 in the schedule 40 is not consulted unless the condition 50 in the same schedule 40 has been met. For example, when a condition in the condition node 50a of the schedule 40a is met, the rule in the rule node 80a is then applied. The rule in the rule node 80a is not applied prior to a condition in the condition node 50a of the schedule 40a being met.

Returning to FIG. 1, an optional type node 90 has been added to the data object 10 at the same hierarchical level as the schedule node 40. The type node 90 can increase the efficiency of the rule checking process. Two types of rules 80 might be designated, which can be referred to as correlated rules and uncorrelated rules. A correlated rule is a rule that might have an effect on or be affected by a rule in another schedule. An uncorrelated rule is a rule that has no relationship with any other rule. In an embodiment, when a condition in a schedule is met, the rule type in the type node 90 in that schedule is checked before the rule in the rule node 80 in that schedule is checked. If the rule is an uncorrelated rule, then it is known that the task associated with that rule is independent of any other schedules and that the rules in the other schedules in the same schedule context 95 need not be consulted. If the rule is a correlated rule, then the rules in the other schedules in the same schedule context 95 are consulted to determine the effects of the rules on one another.

The use of the optional type node 90 can eliminate unnecessary steps in the rule checking process. If the type node 90 were not present, whenever the condition 50 in the schedule 40 is met, the rule 80 in that schedule 40 would check for dependencies on other rules. If it happened that there were no dependencies on other rules, then the checking for dependencies would have been a wasted effort. By designating a rule as uncorrelated, the steps involved in checking for dependencies on other rules can be eliminated.

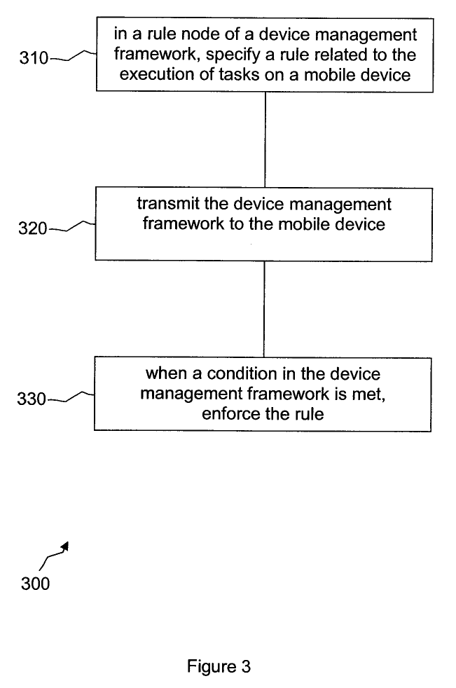

FIG. 3 illustrates a method 300 for controlling the execution of tasks on a mobile device. In box 310, a rule related to the execution of tasks on the mobile device is specified in a rule node of a device management object. The rule can control the execution of the tasks based on parameters in the device management object of which it is a part or on parameters in another device management object. The rule might cause a task to be executed when the conditions for executing that task have not been met or might prevent a task from executing when the conditions for executing that task have been met. In box 320, the device management object is transmitted to the mobile device. In box 330, when a condition in the device management object is met, the rule is enforced.

The use of the rule node 80 to control the execution of tasks on a mobile device allows tasks to be managed in a consistent manner across multiple manufacturers and multiple providers. Complex rules can easily be created and enforced to learn usage patterns and other user-related and device-related information. A provider can easily specify what information to collect and when it should be collected. The provider can then receive this information in a consistent format from different device manufacturers.

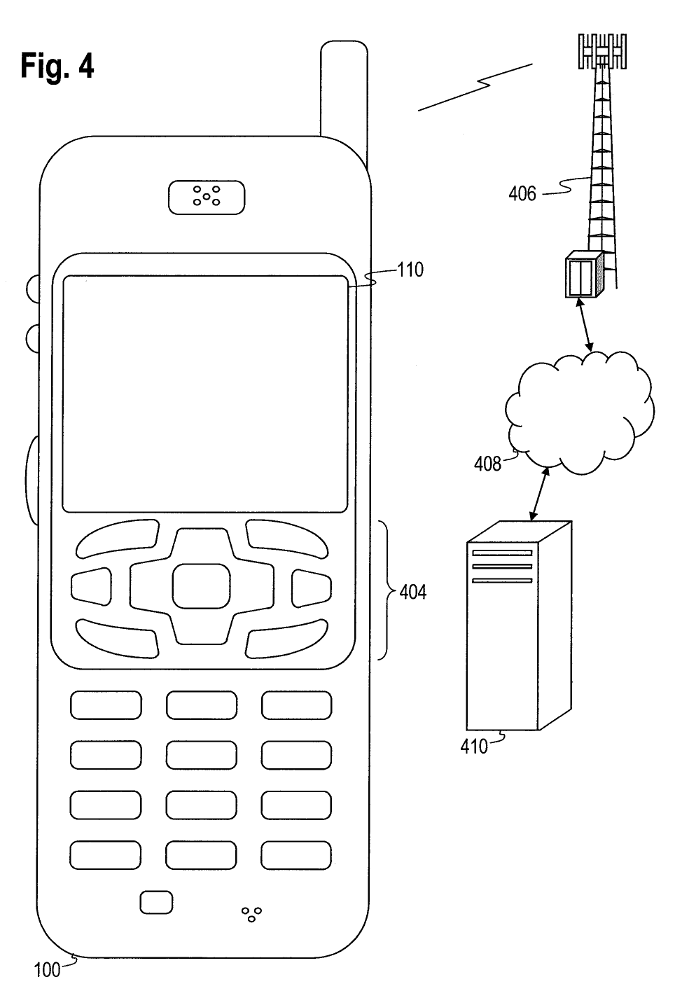

FIG. 4 shows a wireless communications system including a mobile device 100 operable to receive the device management object 10 and to execute a task specified in the device management object 10. The mobile device 100 is operable for implementing aspects of the disclosure, but the disclosure should not be limited to these implementations. Though illustrated as a mobile phone, the mobile device 100 may take various forms including a wireless handset, a pager, a personal digital assistant (PDA), a portable computer, a tablet computer, or a laptop computer. Many suitable mobile devices combine some or all of these functions. In some embodiments of the disclosure, the mobile device 100 is not a general purpose computing device like a portable, laptop or tablet computer, but rather is a special-purpose communications device such as a mobile phone, wireless handset, pager, or PDA.

The mobile device 100 includes a display 110 and a touch-sensitive surface or keys 404 for input by a user. The mobile device 100 may present options for the user to select, controls for the user to actuate, and/or cursors or other indicators for the user to direct. The mobile device 100 may further accept data entry from the user, including numbers to dial or various parameter values for configuring the operation of the mobile device 100. The mobile device 100 may further execute one or more software or firmware applications in response to user commands. These applications may configure the mobile device 100 to perform various customized functions in response to user interaction.

Among the various applications executable by the mobile device 100 are a web browser, which enables the display 110 to show a web page. The web page is obtained via wireless communications with a cell tower 406, a wireless network access node, or any other wireless communication network or system. The cell tower 406 (or wireless network access node) is coupled to a wired network 408, such as the Internet. Via the wireless link and the wired network, the mobile device 100 has access to information on various servers, such as a server 410. The server 410 may provide content that may be shown on the display 110. The server 410 might also send the device management object 15 to the mobile device 100 and receive data sent from the mobile device 100.

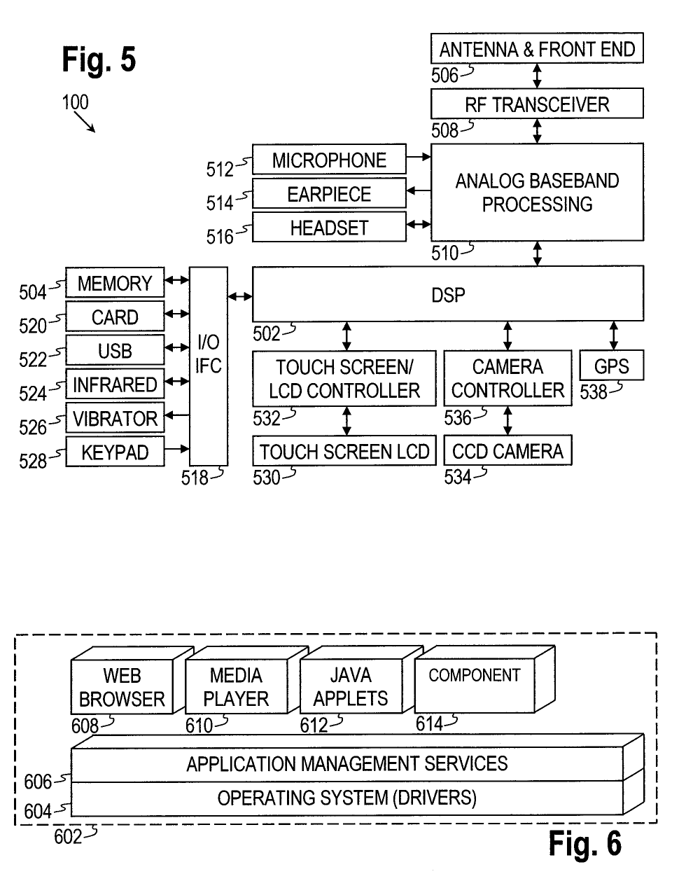

FIG. 5 shows a block diagram of the mobile device 100. The mobile device 100 includes a digital signal processor (DSP) 502 and a memory 504. As shown, the mobile device 100 may further include an antenna and front end unit 506, a radio frequency (RF) transceiver 508, an analog baseband processing unit 510, a microphone 512, an earpiece speaker 514, a headset port 516, an input/output interface 518, a removable memory card 520, a universal serial bus (USB) port 522, an infrared port 524, a vibrator 526, a keypad 528, a touch screen liquid crystal display (LCD) with a touch sensitive surface 530, a touch screen/LCD controller 532, a charge-coupled device (CCD) camera 534, a camera controller 536, and a global positioning system (GPS) sensor 538.

The DSP 502 or some other form of controller or central processing unit operates to control the various components of the mobile device 100 in accordance with embedded software or firmware stored in memory 504. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The antenna and front end unit 506 may be provided to convert between wireless signals and electrical signals, enabling the mobile device 100 to send and receive information from a cellular network or some other available wireless communications network. The RF transceiver 508 provides frequency shifting, converting received RF signals to baseband and converting baseband transmit signals to RF. The analog baseband processing unit 510 may provide channel equalization and signal demodulation to extract information from received signals, may modulate information to create transmit signals, and may provide analog filtering for audio signals. To that end, the analog baseband processing unit 510 may have ports for connecting to the built-in microphone 512 and the earpiece speaker 514 that enable the mobile device 100 to be used as a cell phone. The analog baseband processing unit 510 may further include a port for connecting to a headset or other hands-free microphone and speaker configuration.

The DSP 502 may send and receive digital communications with a wireless network via the analog baseband processing unit 510. In some embodiments, these digital communications may provide Internet connectivity, enabling a user to gain access to content on the Internet and to send and receive e-mail or text messages. The input/output interface 518 interconnects the DSP 502 and various memories and interfaces. The memory 504 and the removable memory card 520 may provide software and data to configure the operation of the DSP 502. Among the interfaces may be the USB interface 522 and the infrared port 524. The USB interface 522 may enable the mobile device 100 to function as a peripheral device to exchange information with a personal computer or other computer system. The infrared port 524 and other optional ports such as a Bluetooth interface or an IEEE 802.11 compliant wireless interface may enable the mobile device 100 to communicate wirelessly with other nearby mobile devices and/or wireless base stations.

The input/output interface 518 may further connect the DSP 502 to the vibrator 526 that, when triggered, causes the mobile device 100 to vibrate. The vibrator 526 may serve as a mechanism for silently alerting the user to any of various events such as an incoming call, a new text message, and an appointment reminder.

The keypad 528 couples to the DSP 502 via the interface 518 to provide one mechanism for the user to make selections, enter information, and otherwise provide input to the mobile device 100. Another input mechanism may be the touch screen LCD 530, which may also display text and/or graphics to the user. The touch screen LCD controller 532 couples the DSP 502 to the touch screen LCD 530.

The CCD camera 534 enables the mobile device 100 to take digital pictures. The DSP 502 communicates with the CCD camera 534 via the camera controller 536. The GPS sensor 538 is coupled to the DSP 502 to decode global positioning system signals, thereby enabling the mobile device 100 to determine its position. Various other peripherals may also be included to provide additional functions, e.g., radio and television reception.

FIG. 6 illustrates a software environment 602 that may be implemented by the DSP 502. The DSP 502 executes operating system drivers 604 that provide a platform from which the rest of the software operates. The operating system drivers 604 provide drivers for the mobile device hardware with standardized interfaces that are accessible to application software. The operating system drivers 604 include application management services (“AMS”) 606 that transfer control between applications running on the mobile device 100. Also shown in FIG. 6 are a web browser application 608, a media player application 610, and Java applets 612. The web browser application 608 configures the mobile device 100 to operate as a web browser, allowing a user to enter information into forms and select links to retrieve and view web pages. The media player application 610 configures the mobile device 100 to retrieve and play audio or audiovisual media. The Java applets 612 configure the mobile device 100 to provide games, utilities, and other functionality. A component 614 might provide functionality related to rule-based execution and scheduling of tasks.

While several embodiments have been provided in the disclosure, it should be understood that the disclosed systems and methods may be embodied in many other specific forms without departing from the spirit or scope of the disclosure. The examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A system comprising:
a component to receive a device management object including a rule node containing a rule that promotes control of execution of a task on a mobile device based on a parameter in a node in the device management object.

2. The system of claim 1, wherein the component is one of a mobile device component and a server component.

3. The system of claim 1, wherein the rule causes at least one of the execution of a first task when a condition for the execution of the first task is not met and the prevention of the execution of a second task when a condition for the execution of the second task is met.

4. The system of claim 1, wherein the execution of the task is based on information in at least one of a condition node, a user interface node, a task node, a reporting node, a state node, an initial state node, an extension node, and the rule node in the at least one of the device management object and the other device management object.

5. The system of claim 4, wherein a condition in the condition node is evaluated before the rule is evaluated.

6. The system of claim 1, wherein the rule allows a first schedule in a first device management object to have an effect on a second schedule in a second device management object.

7. The system of claim 6, wherein the first schedule and the second schedule are in a single schedule context.

8. The system of claim 6, further comprising a type node operable to allow the rule to be designated as an uncorrelated rule, and when the rule has been designated as an uncorrelated rule, the type node operable to prevent the evaluation of a second rule in the second device management object.

9. The system of claim 1, wherein the nodes in the device management object comply with an Open Mobile Alliance standard.

10. A system, comprising:
a server; and
a mobile device including:
a first component operable to receive a device management object from the server, the device management object operable to contain a rule operable to control execution of a task on the mobile device based on at least one parameter in at least one node in at least one of the device management object and another device management object, and
a second component operable to send data generated by the execution of the task to the server.

11. The system of claim 10, wherein the rule causes at least one of the execution of a first task when a condition for the execution of the first task is not met and the prevention of the execution of a second task when a condition for the execution of the second task is met.

12. The system of claim 10, wherein the execution of the task is based on information in at least one of a condition node, a user interface node, a task node, a reporting node, a state node, an initial state node, an extension node, and the rule node in the at least one of the device management object and the other device management object.

13. The system of claim 12, wherein a condition in the condition node is evaluated before the rule is evaluated.

14. The system of claim 10, wherein the rule allows a first schedule in a first device management object to have an effect on a second schedule in a second device management object.

15. The system of claim 14, wherein the first schedule and the second schedule are in a single schedule context.

16. The system of claim 14, further comprising a type node operable to allow the rule to be designated as an uncorrelated rule, and when the rule has been designated as an uncorrelated rule, the type node operable to prevent the evaluation of a second rule in the second device management object.

17. A method for controlling an execution of a task on a mobile device, comprising:
specifying a rule in a rule node in a device management object, the rule related to execution of the task, the rule operable to cause at least one of the execution of a first task when a first condition for the execution of the first task is not met and the prevention of the execution of a second task when a second condition for the execution of the second task is met;
transmitting the device management object to the mobile device; and
when at least one of the first condition and the second condition are met, enforcing the rule.

18. The method of claim 17, further comprising basing the execution of the task on information in at least one of a condition node, a user interface node, a task node, a reporting node, a state node, an initial state node, an extension node, and the rule node in the at least one of the device management object and the other device management object.

19. The method of claim 17, further comprising a first schedule in a first device management object having an effect on a second schedule in a second device management object, and wherein the first schedule and the second schedule are contained in a single schedule context.

20. The method of claim 19, further comprising including a type node in the device management object, the type node operable to allow the rule to be designated as an uncorrelated rule, and when the rule has been designated as an uncorrelated rule, the type node operable to prevent the evaluation of a second rule in the second device management object.
